(19) United States
(12) Patent Application Publication
(10) Pub. No.: US 2024/0035853 A1
(43) Pub. Date: Feb. 1, 2024

(54) METHOD FOR DETECTING ERRONEOUS MEASUREMENT SIGNAL OUTPUTS FROM A FIELD DEVICE, DETECTION SYSTEM AND FIELD DEVICE

(71) Applicant: VEGA Grieshaber KG, Wolfach (DE)

(72) Inventors: Clemens Hengstler, Haslach (DE); Stefen Kaspar, Hofstetten (DE)

(21) Appl. No.: 18/256,583

(22) PCT Filed: Dec. 9, 2020
(86) PCT No.: PCT/EP2020/085241

§ 371 Date: Jun. 8, 2023

(51) Int. Cl. G01D 3/08; G01D 21/00

(52) U.S. Cl. CPC G01D 3/08; G01D 21/00

(57) ABSTRACT

A method for the detection of incorrect measurement signal outputs of a field device, comprising: outputting of a measurement value by the field device as a first measurement signal, outputting of the measurement value by the field device as a second measurement signal, receiving by a detection system the first measurement signal and the second measurement signal or values derived therefrom, determining a measurement signal deviation between the first measurement signal and the second measurement signal by the detection system, and checking by the detection system whether a case of error is present, taking into account the measurement signal deviation and, optionally, taking into account at least one further error condition. The invention further relates to a detection system that can be used for carrying out the above-described method. According to another aspect of the invention, a field device is proposed that is suitable for carrying out the above-described method.

### CROSS REFERENCE TO RELATED APPLICATIONS

This application is a US National Phase of PCT Application Serial Number PCT/EP2021/084241 filed Dec. 9, 2020, which published as PCT Publication WO2022/122147, which is hereby incorporated by reference herein in its entirety.

### FIELD OF THE INVENTION

The invention relates to a method for the detection of incorrect measurement signal outputs of a field device. The invention further relates to a detection system for recognizing incorrect measurement signal outputs of a field device. Moreover, the invention relates to a field device.

### BACKGROUND OF THE INVENTION

Various technical devices that are directly related to a production process are subsumed under the term field device. Here, “field” refers to the area outside of control centers. Thus, field devices may be, in particular, actuators, sensors and measuring transducers.

Field devices that serve for recording and/or influencing process variables are often used in process automation engineering. Filling level measuring devices, limit level measuring devices and pressure measuring devices with sensors recording the respective process variables filling level, limit level or pressure are examples of such field devices. Typical areas of use of such field devices include areas such as flood forecasting, inventory management or also other decentralized measuring tasks. Known field devices of the above-mentioned type make it possible to transmit measurement values, so that a higher-level unit triggers a predetermined action based on the acquired measurement value. For example, based on the measurement value of a filling level measuring device, a feed pipe may be closed, or a drainage pipe opened, when a threshold value is exceeded.

Field devices are to be positioned directly at the measurement point. They are generally supplied with power by cable. A measurement value may be transmitted as an analog current signal between 4 mA and 20 mA, for instance. This type of signal transmission is standardized in DIN IEC 60381-1 (analog signals for process control systems; analog direct current signals). Nevertheless, measurement values may also be transmitted as voltage signals. A remote station may receive the analog voltage signals and determine measurement values therefrom.

An analog transmission of measurement values by cable is very simple and has further advantages. For example, a field device may be supplied with power via a two-wire system, for example, but at the same time, the two-wire system may also serve for transmitting measurement values. However, if an error occurs during the transmission of measurement values, this may have severe consequences. Many cases of error cannot be discovered remotely due to the analog connection of the field device. This is the case particularly for measurement value deviations.

Document EP 1 864 268 B1 describes an interface of a field device to a two-wire system. The interface controls an outputted amperage. In order to find output errors, the interface is equipped with a checking circuit. The checking circuit measures an amperage in the two-wire system and is thus capable of determining whether a desired amperage is applied to the two-wire system. If this is not the case, a calibrating process may be triggered. In this way, errors can be detected and resolved directly in the field device. However, due to the necessary checking circuit, the field device has a more complex structure. Checking the field device remotely is not possible.

### SUMMARY OF THE INVENTION

Therefore, the invention is based on specifying a method that permits a remote detection of incorrect measurement signal outputs of a field device. Another object of the invention is to provide a detection system that permits a remote detection of incorrect measurement signal outputs of a field device. It is another object of the invention to specify a field device whose measurement signal output can be checked remotely.

Various mutually independent advantageous developments of the present invention can be freely combined with each other by the person skilled in the art within the context of what is technically feasible. In particular, this also applies across the boundaries of the various categories of the claims.

According to a first aspect of the invention, a method for the detection of incorrect measurement signal outputs of a field device is proposed, which comprises the steps: outputting of a measurement value by the field device as a first measurement signal, outputting of the measurement value by the field device as a second measurement signal, receiving by a detection system the first measurement signal and the second measurement signal or values derived therefrom, determining a measurement signal deviation between the first measurement signal and the second measurement signal by the detection system, and checking by the detection system whether a case of error is present, taking into account the measurement signal deviation and, optionally, taking into account at least one further error condition.

This is advantageous in that an external error detection is possible. No expensive components for reading back the first measurement signal need to be incorporated into the field device itself. In principle, a plurality of field devices can be monitored by means of the detection system. The functional safety of the field device is increased: states of faulty operation, e.g. caused by damage or a manipulation of the field device can be recognized.

Preferably, the first measurement signal and the second measurement signal represent a measurement value determined by a sensor or sensors of the field device. The detection system can directly receive the first and second measurement signals. However, it is also possible that the detection system receives only values derived from the first measurement signal and/or the second measurement signal. This is the case, for example, if an intermediate station receives the first measurement signal, subjects the first measurement signal to an analog/digital conversion, and then forwards the measurement signal thus digitized to the detection system in the form of a measurement data packet.

According to the invention, the first and second measurement signals can be outputted by means of different communication interfaces of the field device. Alternatively, however, it is also possible that the first measurement signal and the second measurement signal are outputted via the same communication interface of the field device. The crucial point is that, due to the two-fold outputting of the measurement value, it is possible to check whether it has been transmitted correctly.

It is advantageous if the first measurement signal is outputted via a cable-connected interface of the field device, and the second measurement signal is outputted via a radio interface of the field device. A redundancy is thus provided by means of a radio transmission. For example, Bluetooth, LoRaWAN (Long Range Wide Area Network), NB-IoT (NarrowBand-IoT), LTE-M (Long-Term-Evolution) or any other radio transmission technology may be used as a radio transmission technology. Alternatively, the first measurement signal can be outputted via a cable-connected interface of the field device, and the second measurement signal can also be outputted via a cable-connected interface of the field device. Consequently, a redundancy is provided by means of a transmission via two different data cables.

According to an advantageous embodiment of the invention, the first measurement signal is an analog measurement signal, and the second measurement signal is a digital measurement signal. According to a variant of the invention, the first measurement signal thus can be outputted in an analog manner by cable, and the second measurement signal in a digital manner by radio transmission. According to another variant of the invention, both the first measurement signal and the second measurement signal are transmitted by cable, e.g. via two separate data cables. In this case, the second measurement signal could be transmitted by means of a standard such as Ethernet, Profibus or IO-Link, for example. According to another embodiment of the invention, the first measurement signal and the second measurement signal are transmitted via the same data cable, wherein the first measurement signal is an analog measurement signal, and the second measurement signal is a digital measurement signal. According to the invention, this could be realized by modulating the second measurement signal having a digital form onto the first measurement signal having an analog form. This is possible by means of the fieldbus protocol HART (Highway Addressable Remote Transducer), for example.

When determining the measurement signal deviation between the analog measurement signal and the digital measurement signal using the detection system, a check is preferably carried out whether the analog measurement signal and the digital measurement signal correspond to each other. If they do not, this generally the result of either the analog measurement signal or the digital measurement signal being corrupted. Due to the robustness of the digital signal transmission and of methods for error recognition and correction that can be applied thereto, it is to be presumed that, in the case of a deviation between the analog measurement signal and the digital measurement signal, the analog measuring signals are corrupted in a majority of the cases. The corruption may be the result of a hardware error of the field device, but may also be caused by damage or malfunction of a cable-connected communication line. It should be understood that, in order to determine the measurement signal deviation, the field device does not necessarily have to process the analog measurement signal and the digital measurement signal directly, but for this purpose may also work with values derived therefrom. When the detection system checks whether a case of error exists, various criteria may be used. In particular, it is not only a result of the determination of the measurement signal deviation that has to be evaluated, rather, other parameters and/or system states may also be evaluated.

It is preferred if, for determining the measurement signal deviation, the analog measurement signal and the digital measurement signal are normalized to a matching unit, so as to result in normalized values, and a difference between the normalized values is then calculated. Normalization is to be understood to mean a step which makes the analog measurement signals comparable to the digital measurement signals. For the purpose of normalization, the analog measurement signal and/or the digital measurement signal may be converted into another unit.

It is advantageous if the determination of the measurement signal deviation comprises the following steps: providing an analog nominal measurement value by converting the digital measurement value into an analog unit, providing an analog actual measurement value on the basis of the analog measurement signal, and calculating a difference between the analog nominal measurement value and the analog actual measurement value. The analog nominal value is based on the digital measurement signal and specifies an expected current or expected voltage, for example. In order to be able to compare the analog nominal value with the analog measurement signal, the analog actual value has to be provided. For this purpose, according to the invention, the detection system can convert the analog measurement signal into a digital format by analog/digital conversion. The analog actual value is possibly already available to the detection system in a digital form, because a recording unit disposed between the field device and the detection system has recorded the analog measurement signal, converted it accordingly and forwarded it to the detection system in the form of a measurement data packet. It is now possible to check whether the analog nominal value corresponds to the analog actual value. For this purpose, the difference between the analog nominal value and the analog actual value is calculated. According to an advantageous embodiment of the invention, the analog measurement signal may be an amperage. Consequently, it is checked in this case whether an amperage of the analog measurement signal corresponds to an amperage expected on the basis of the digital measurement signal.

Alternatively, the above-described comparison of the analog measurement signal with the digital measuring signal may, however, also be implemented in a different way. Thus, according to a possible embodiment of the invention, the analog measurement signal and the digital measurement signal are converted into a measurement value, e.g. into a pressure measured by the field device. This results in two pressure values. The pressure values may then be compared to each other. According to the invention, however, the comparison of the analog measurement signal to the digital measurement signal is possible also by means of other calculation methods.

Preferably, the method includes outputting a configuration data set of the field device by the field device and receiving the configuration data set by the detection system. The configuration data set preferably contains configuration data of the field device. In particular, the configuration data set may contain configuration data that indicate the relationship between the measurement value measured by the field device and the analog measurement value. According to the invention, the configuration data set may, according to the invention, contain at least one conversion factor and/or offset value. For example, the field device could be configured such that, if it measures a pressure of 1 bar, it outputs a current of 4 mA as the analog measurement signal, and a current of 20 mA if it measures a pressure of 2 bars. The configuration data set contains information that permit a remote station to calculate, based on a measured current of 12 mA, for example, that the field device has measured a pressure of 1.5 bars.

It is advantageous if, when determining the measurement signal deviation, the detection system uses the configuration data set for normalizing the analog measurement signal and the digital measurement signal to the matching unit. Only when the measurement signals are normalized do they become comparable. Incidentally, however, variants of the invention are also possible in which configuration data that indicate the relationship between the measurement value measured by the field device and the analog measurement value are manually inputted into the detection system.

According to a special embodiment of the method according to the invention, a recording unit records the analog measurement signal, wherein the recording unit carries out an analog-digital conversion of the analog measurement signal into a measurement data packet, and wherein the recording unit transmits the measurement data packet to the detection system. The recording unit preferably is a device for controlling the field device and/or for evaluating the measurement values recorded by the field device. Frequently, the recording unit is arranged close to the field device in space, and may also serve for supplying it with power. The recording unit can record the analog measurement signal and forward it to the detection system, e.g. in the form of a measurement data packet containing the analog measurement signal in a digitized form. The recording unit may have a radio interface, for example, in order to be able to communicate with the detection system. According to other embodiments, however, a communication with the detection system is also possible in another way, e.g. via a communications network such as the internet. Moreover, embodiments of the invention are possible in which the recording unit and the detection system are combined with each other. Thus, the detection system may be integrated into the recording unit, for example.

According to the invention, it is possible that the recording unit furnishes the measurement data packet with a time stamp. The time stamp preferably marks a point in time at which the recording unit has received the analog measurement signal. This permits the detection system to check whether the analog measurement signal and the digital measurement signal have been outputted by the detection system within a short time frame.

According to advantageous variants of the method proposed according to the invention, it may be provided that the first measurement signal and the second measurement signal are outputted, in terms of time, in a spaced-apart manner by the field device. Thus, the measurement signals that are compared with each other have been outputted at different points in time, e.g. on different days, but shorter or longer intervals are also possible. This is permissible particularly if the measurement values recorded by the field device do not change very quickly. In contrast, if the measurement values recorded by the field device change relatively quickly, the first measurement signal and the second measurement signal have to be outputted by the field device within a sufficiently short period of time. According to the invention, a size of a time frame, from which the first and second measurement signal may originate so that they can be compared to one another in accordance with the method according to the invention, can be predefined. If a comparatively large time frame is set, the second measurement signal has to be transmitted via the radio interface only comparatively rarely. Thus, less power for transmitting the second measurement signals is required.

In order to be able to check that the measurement signals are not spaced apart too far in terms of time, the field device preferably furnishes the second measurement signal with a time stamp. This can be implemented particularly if the second measurement signal is a digital measurement signal. According to the invention, it is also possible that the detection system logs points in time at which the first measurement signal, the second measurement signal or values derived therefrom arrive at the detection system. Accordingly, intervals in time can be determined accordingly.

It is preferred if the detection system, when checking whether a case of error is present, determines whether a threshold value predefined for the measurement signal deviation is exceeded. For example, if it is to be expected, based on the second measurement signal, that the field device outputs as the first measurement signal a current of 6 mA, and if a threshold of 1 mA is provided, then first measurement signals of 5.1 mA or 6.5 mA outputted by the field device are also admissible, but a measurement signal of 7.5 mA is not. Slight deviations of the measurement signal that do not distort the measurement value too much may thus be ignored.

It is particularly preferred if the detection system, when checking whether a case of error is present, takes into account several pairs of first and second measurement signals, wherein the pairs of first and second measurement signals have been outputted, in terms of time, in a spaced-apart manner by the field device. Consequently, several measurement signal comparisons are carried out, according to advantageous embodiments even across a longer period of time. Results of the measurement value comparisons may be averaged, for example. Thus, a temporary malfunction or a short-term deviation of the measurement signals is not necessarily classified as a case of error.

It is advantageous if the detection system, when checking whether a case of error is present, measures a time span since receiving the last second measurement signal or a value derived therefrom and ascertains the presence of the case of error if the measured time span exceeds a predefined maximum time span. Thus, it is checked that second measurement signals, or values derived therefrom, are not received by the detection system with a delay that is too long. If this is not the case, incorrect measurement signal outputs of the field device can no longer be identified. According to this embodiment of the invention, this is classified as a case of error.

The first measurement signal is preferably a current signal. Thus, an amperage is outputted that represents a measurement value measured by the field device. Alternatively, the first measurement signal may be a voltage signal, or a signal of another kind.

It is preferred if the field device outputs the first measurement signal via a two-wire system. The two-wire system preferably has an outgoing conductor and a return conductor. The two-wire system is suitable for supplying the field device with power. Moreover, data, in the present case the first measurement signal, are transmitted in an analog form via the two-wire system. Thus, a simple and compact implementation of both the power supply and device communications is provided. This is very advantageous when recording measurement values particularly in locations that are difficult to access.

The transmission of data via the radio interface of the field device is preferably encrypted. Data transmitted via the radio interface are preferably checked for errors by the detection system, by comparing a checksum, such as a CRC code or the like. Preferably, the transmission via the radio interface takes place at regular intervals. According to the invention, it is also possible that the previously mentioned configuration data set is transmitted to the detection system by means of the radio interface. The second measurement signal is either directly received by the detection system or reaches it indirectly, possibly by forwarding via various nodes. In principle, the detection system may be a computer or a group of several computers, wherein the computer or group of computers may be equipped with communication interfaces of various types. In particular, the detection system may be implemented by a cloud system, on which a software for monitoring field devices runs.

Preferably, the detection system outputs an error signal when ascertaining the presence of the case of error. The error signal is to be understood to mean a signal that serves for notifying a remote station of the possibility that the field device is no longer functional, that the communication with the field device may no longer work, or that another case of error has occurred. Thus it is possible, for instance, that the detection system notifies a person responsible of the case of error by E-mail, by text message, by push message in an app or in another manner. The person responsible can then take suitable measures to avoid or minimize consequential damage due to the presumably defective field device.

It is advantageous if the detection system, if the case of error is present, transmits to the field device a command for putting the field device into a safe state. In a field device outputting the measurement values as analog current signals, only values of less than 3.6 mA or greater than 21 mA are then outputted, which are not valid measurement signals. Further, it is conceivable to shut down the field device by an external command. According to the invention, it is also possible that the detection system, if the case of error is present, transmits to the field device a command for restarting the field device. Moreover, it is possible according to the invention that the person responsible transmits to the field device a command for putting the field device into a safe state, for shutting down the field device, or for restarting the field device.

According to a another aspect of the invention, a detection system for recognizing incorrect measurement signal outputs of a field device is proposed, which is configured for carrying out the following steps: receiving a first measurement signal, receiving a second measurement signal, determining a measurement signal deviation between the first measurement signal and the second measurement signal, and checking whether a case of error is present, taking into account the measurement signal deviation and, optionally, taking into account at least one further error condition. The detection system preferably has a radio interface and is configured for receiving the second measurement signals via the radio interface. Also, it is advantageous if the detection system has a cable-connected interface and is configured for receiving the first measurement signals via the cable-connected interface. The radio interface preferably forms a part of the detection system. The detection system is preferably implemented by a system of distributed computers linked together in a network. The detection system is preferably suitable for carrying out the above-described method and has features necessary for this purpose.

According to another aspect of the invention, a field device is proposed, which has at least one sensor unit for recording a measurement value, wherein the field device is configured for outputting the measurement value as a first measurement signal and as a second measurement signal. It is preferred if the field device has a cable-connected interface and a radio interface, wherein the field device is configured for outputting the first measurement signal via the cable-connected interface and the second measurement signal via the radio interface. Irrespective of the type of interfaces used, the first measurement signal preferably is an analog measurement signal, and the second measurement signal is a digital measurement signal. Preferably, the field device is a filling level measuring device, a limit level measuring device or a pressure measuring device. Thus, the sensor unit may be a capacitive pressure measuring cell, for instance, but also a sensor unit of another type, depending on the application. The field device is preferably suitable for carrying out the above-described method and has features necessary for this purpose.

It is advantageous if the field device is incapable of receiving data via the radio interface or of processing data received via the radio interface as commands. It is thus prevented that the field device can be manipulated by external commands. According to an alternative embodiment of the invention, the radio interface permits the reception of data. A field device according to this embodiment is preferably configured such that, by means of an external command, it can be put into a safe operating state and/or be turned off.

### BRIEF DESCRIPTION OF THE DRAWINGS

Aspects of the invention are explained by way of example with reference to the Figures. In the Figures:

FIG. 1 shows a schematic illustration of a computer topology with a field device, a recording unit and a detection system,

FIG. 2 shows a flow chart of the method according to the invention for detecting incorrect measurement signal outputs, and

FIG. 3 shows a flow chart explaining partial steps of the method according to the invention in more detail.

### DETAILED DESCRIPTION OF THE DRAWINGS

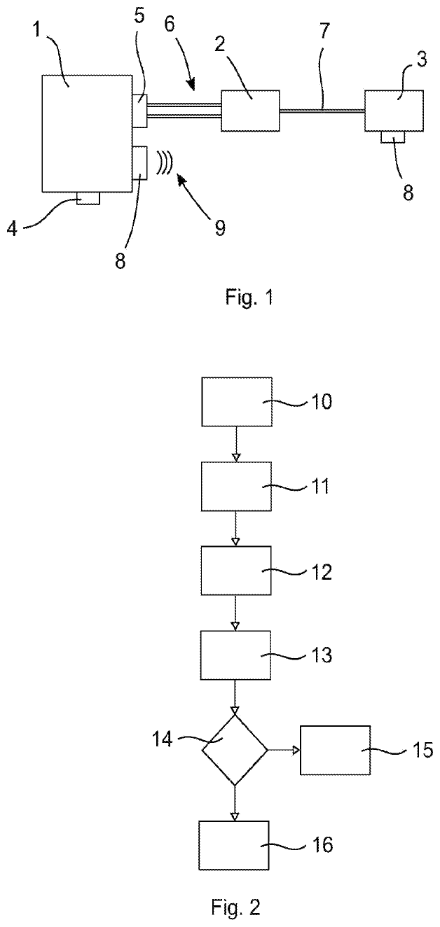

FIG. 1 shows a schematic illustration of a computer topology with a field device 1, a recording unit 2 and a detection system 3. The field device 1 has a sensor unit 4, which is a capacitive pressure measuring cell. For example, a pressure of a surrounding fluid can be measured by means of the latter. The field device 1 has a cable-connected interface 5 for outputting a measurement value. The cable-connected interface 5 permits outputting current signals via a two-wire system 6. The two-wire system 6 further serves for supplying the field device 1 with power. The field device 1 is connected to the recording unit 2 via the two-wire system 6. The recording unit 2 supplies the field device 1 with current via the two-wire system 6. The recording unit 2 reads in first measurement signals, which the field device 1 outputs via the two-wire system 6. The first measurement signals are analog measurement signals. The recording unit converts the analog measurement signals into a digital form and sends them as measurement data packets via a communications network 7 to the detection system 3. The field device 1 further has a radio interface 8 that outputs second measurement signals. The radio interface 8 transmits the second measurement signals as radio signals 9, which represent the measurement value in a digital form. Thus, the second measurement signals are digital measurement signals. The radio signals 9 are received by another radio interface 8 associated with the detection system 3. The detection system 3 is a cloud computer network executing a computer program for monitoring field devices 1.

FIG. 2 shows a flow chart of the method according to the invention for detecting incorrect measurement signal outputs. In a measuring step 10, the above-described field device measures a pressure. In an outputting step 11, the pressure is outputted via the cable-connected interface of the field device and via the radio interface of the field device, as the first and second measurement signal, respectively. In the process, the field device outputs the measurement value as an amperage via the two-wire system, and in addition transmits the measurement value in a digital form via its radio transmitter. In a receiving step 12, the detection system receives a measurement data packet derived from the first measurement signal, and the second measurement signal. The receiving step 12 is preceded by the recording unit measuring the amperage of the first measurement signal, converting the former into a digital format, generating the measurement data packet therefrom and transmitting the measurement data packet to the detection system.

In a determining step 13, a measurement signal deviation between the first measurement signal and the second measurement signal is determined. If the first measurement signal does not match the second measurement signal, an error may be present. The error may be caused by an error in the field device or by a communication error. In a checking step 14, the detection system checks whether a case of error is present. This is the case, for example, if the measurement signal deviation exceeds a predefined value. However, the detection system also checks whether it regularly receives second measurement signals. If that is no longer the case, then this suggests an error in the field device. In the event of a case of error, the checking step is followed by an informing step 15. In the informing step, a person responsible is notified by the detection system, by means of an E-mail or a push message in an app, that the field device no longer works faultlessly. If no case of error is present, then the detection system only stores the determined measurement signal deviation in a logging step 16.

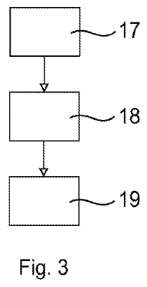

FIG. 3 shows a flow chart explaining partial steps of the method according to the invention in more detail. The partial steps are carried out in the above-described determining step. In a configuring step 17, the field device transmits to the detection system a configuration data set of the field device via its radio interface. The configuration data set contains information that permits the first measurement signal to be calculated from the second measurement signal. In a normalization step 18, the detection system normalizes the first measurement signal and the second measurement signal to a matching unit. In the present case, the matching unit is the unit of the first measurement signal; here, an amperage in mA. The measurement data packet, which is derived from the first measurement signal and with which the detection system is provided, already specifies the current in mA. Thus, only the second measurement signal has to be converted into the unit mA. This is done with the help of the configuration data set. Finally, in a subtracting step 19, the difference between the normalized measurement signals is calculated. A large difference suggests that the analog measurement signal does not correctly represent the actual measurement value.

### REFERENCE SIGNS LIST

1 Field device
2 Recording unit
3 Detection system
4 Sensor unit
5 Cable-connected interface
6 Two-wire system
7 Communications network
8 Radio interface
9 Radio signal
10 Measuring step
11 Outputting step
12 Receiving step
13 Determining step
14 Checking step
15 Informing step
16 Logging step
17 Configuring step
18 Normalization step
19 Subtracting step

1. A method for the detection of incorrect measurement signal outputs of a field device, comprising the steps:
outputting of a measurement value by the field device as a first measurement signal,
outputting of the measurement value by the field device as a second measurement signal,
receiving by a detection system the first measurement signal and the second measurement signal or values derived therefrom,
determining a measurement signal deviation between the first measurement signal and the second measurement signal by the detection system, and
checking by the detection system whether a case of error is present, taking into account the measurement signal deviation and, optionally, taking into account at least one further error condition.

2. The method according to claim 1, wherein the first measurement signal is outputted via a cable-connected interface of the field device, and the second measurement signal is outputted via a radio interface of the field device.

3. The method according to claim 1, wherein the first measurement signal is an analog measurement signal, and that the second measurement signal is a digital measurement signal.

4. The method according to claim 3, wherein, for determining the measurement signal deviation, the analog measurement signal and the digital measurement signal are normalized to a matching unit, so as to result in normalized values, and a difference between the normalized values is then calculated.

5. The method according to claim 3, wherein the determination of the measurement signal deviation comprises the following steps:
providing an analog nominal measurement value by converting the digital measurement value into an analog unit,
providing an analog actual measurement value on the basis of the analog measurement signal, and
calculating a difference between the analog nominal measurement value and the analog actual measurement value.

6. The method according to claim 4, wherein the method further comprises the steps of:
outputting a configuration data set of the field device by the field device, and receiving the configuration data set by the detection system.

7. The method according to claim 6, wherein characterized in that when determining the measurement signal deviation, the detection system uses the configuration data set for normalizing the analog measurement signal and the digital measurement signal to the matching unit.

8. The method according to claim 3, wherein a recording unit records the analog measurement signal, wherein the recording unit carries out an analog-digital conversion of the analog measurement signal into a measurement data packet, and wherein the recording unit transmits the measurement data packet to the detection system.

9. The method according to claim 8, wherein the recording unit furnishes the measurement data packet with a time stamp.

10. The method according to claim 1, wherein the first measurement signal and the second measurement signal are outputted, in terms of time, in a spaced-apart manner by the field device.

11. The method according to claim 1, wherein the field device furnishes the second measurement signal with a time stamp.

12. The method according to claim 1, wherein the detection system, when checking whether a case of error is present, determines whether a threshold value predefined for the measurement signal deviation is exceeded.

13. The method according to claim 1, wherein the detection system, when checking whether a case of error is present, takes into account several pairs of first and second measurement signals, wherein the pairs of first and second measurement signals have been outputted, in terms of time, in a spaced-apart manner by the field device.

14. The method according to claim 1, wherein the detection system, when checking whether a case of error is present, measures a time span since receiving the last second measurement signal or a value derived therefrom and ascertains the presence of the case of error if the measured time span exceeds a predefined maximum time span.

15. The method according to claim 1, wherein the first measurement signal is a current signal.

16. The method according to claim 1, wherein the field device outputs the first measurement signal via a two-wire system.

17. The method according to claim 1, wherein the detection system outputs an error signal when ascertaining the presence of the case of error.

18. The method according to claim 1, wherein the detection system, if the case of error is present, transmits to the field device a command for putting the field device into a safe state.

19. The method according to claim 1, wherein the detection system, if the case of error is present, transmits to the field device a command for restarting the field device.

20. A detection system for recognizing incorrect measurement signal outputs of a field device, the detection system being configured for carrying out at least the following steps:
receiving a first measurement signal,
receiving a second measurement signal,
determining a measurement signal deviation between the first measurement signal and the second measurement signal, and
checking whether a case of error is present, taking into account the measurement signal deviation and, optionally, taking into account at least one further error condition.

21. A field device with at least one sensor unit for recording a measurement value, wherein the field device is configured for outputting the measurement value as a first measurement signal and as a second measurement signal.

22. The field device according to claim 21, wherein the field device has a cable-connected interface and a radio interface, wherein the field device is configured for outputting the first measurement signal via the cable-connected interface and the second measurement signal via the radio interface.

23. The field device according to claim 22, wherein the field device is incapable of receiving data via the radio interface or of processing data received via the radio interface as commands.
